(19) United States
(12) Patent Application Publication
(10) Pub. No.: US 2016/0336582 A1
(43) Pub. Date: Nov. 17, 2016

(54) BATTERY MODULE

(71) Applicant: SAMSUNG SDI CO., LTD., Yongin-si (KR)

(72) Inventors: Sang-Won BYUN, Yongin-si (KR); Jeong-Won OH, Yongin-si (KR); Min-Yeol HAN, Yongin-si (KR); Yong-Chul SEO, Yongin-si (KR); Seung-Ho KWAK, Yongin-si (KR)

(21) Appl. No.: 14/944,110

(22) Filed: Nov. 17, 2015

(30) Foreign Application Priority Data
May 15, 2015 (KR) 10-2015-0068239

(51) Int. Cl. H01M 2/34; H01M 2/06; H02J 7/00

(52) U.S. Cl. CPC H01M 2/348; H02J 7/0029; H01M 2/06; H02J 2007/0037; H01M 2200/103; H01M 2220/20

(57) ABSTRACT

A battery module includes: a plurality of rechargeable batteries electrically connected in series with each other, each including a short-circuit member that is deformable according to an increase of an internal pressure; and a fuse member including a connection plate overlapping the short-circuit member and a fuse including a first end connected with the connection plate and a second end connected with a first electrode or a second electrode of one of a first rechargeable battery and a second rechargeable battery located at an end along the plurality of rechargeable batteries.

### CROSS-REFERENCE TO RELATED APPLICATION

This application claims priority to and the benefit of Korean Patent Application No. 10-2015-0068239, filed on May 15, 2015 in the Korean Intellectual Property Office, the entire content of which is incorporated herein by reference.

### BACKGROUND

1. Field

Aspects of embodiments of the present invention relate to a battery module.

2. Description of the Related Art

Unlike a primary battery, a rechargeable battery can iteratively perform charging and discharging. A small sized rechargeable battery may be used as a power supply for small electronic devices such as cellular phones, notebook computers, and camcorders, while a medium or large sized rechargeable battery may be used as a power supply for driving motors, such as in hybrid vehicles, electric vehicles, and the like.

The rechargeable battery may be used as a single-cell battery, as in a small electronic device, or may be used as a module in which a plurality of cells are electrically connected, as in motor driving, for example. The rechargeable battery module is formed by connecting electrode terminals: of unit cells through a bus bar.

The plurality of rechargeable batteries are electrically connected, and thus even though an event such as an overcharging, penetration, or external short circuit may occur in one unit battery among the plurality of rechargeable batteries, an over-current flowing from the unit battery where the event occurred flows to the last unit battery, thereby causing damage to unit batteries where the event did not occur.

The above information disclosed in this Background section is only for enhancement of understanding of the background of the invention and therefore it may contain information that does not form the prior art that is already known in this country to a person of ordinary skill in the art.

### SUMMARY

According to an aspect of embodiments of the present invention, a battery module has improved safety with respect to abnormal operation of a rechargeable battery. A battery module according to embodiments of the present invention can prevent or substantially prevent damage to all rechargeable batteries that are connected with each other.

Further, according to another aspect of embodiments of the present invention, a battery module has improved safety by disconnecting flow of short-circuit current upon occurrence of overcharging.

A battery module according to one or more exemplary embodiments of the present invention Includes: a plurality of rechargeable batteries electrically connected in series with each other, each including a short-circuit member that is deformable according to an increase of an internal pressure; and a fuse member including a connection plate overlapping the short-circuit member and a fuse including a first end connected with the connection plate and a second end connected with a first electrode or a second electrode of one of a first rechargeable battery and a second rechargeable battery located at an end along the plurality of rechargeable batteries.

The fuse member may be connected with the second electrode of the second rechargeable battery.

The fuse may be formed narrower than the width of one end of the fuse member, connected with the connection plate.

The battery module may further include: a first draw-out tab connected with the first electrode of the first rechargeable battery; and a second draw-out tab connected with the fuse member.

The battery module may include at least one unit group, each including an odd number of rechargeable batteries of the plurality of rechargeable batteries.

The fuse member may include one or more fuse members overlapping a short-circuit member of a rechargeable battery included in each unit group.

The connection plate of each of the one or more fuse members may overlap the short-circuit member of a second rechargeable battery located at an end of the rechargeable batteries included in each of the unit groups.

The rechargeable battery may include an electrode assembly including a positive electrode and a negative electrode and configured to perform charging and discharging, a case in which the electrode assembly is installed, and a cap plate combined to the case, and; the cap plate and the first electrode may be electrically connected with the positive electrode, and the second electrode may be electrically connected with the negative electrode.

The cap plate may have a shape of a plate having a length direction and a width direction, and the short-circuit member may be arranged closer to a center of the length, direction of the cap plate than the second electrode.

The cap plate may include a short-circuit hole penetrating the cap plate, and the short-circuit member may include an edge portion fixed to the cap plate in the short-circuit hole.

The connection plate may include protrusions protruded toward the short-circuit hole.

According to an aspect of one or more exemplary embodiments of the present invention, allow of a short-circuit current can be easily blocked by using a fuse module in a battery module such that damage to the battery module can he minimized or reduced, while improving safety of the battery module.

### BRIEF DESCRIPTION OF THE DRAWINGS

FIG. 1 illustrates a perspective view of a battery module according to an exemplary embodiment of the present invention.

FIG. 2 illustrates a perspective view of a fuse member provided in a battery module, according to an exemplary embodiment of the present invention.

FIG. 3 illustrates a perspective view of a rechargeable battery of the rechargeable battery/module of FIG. 1, according: to an exemplary embodiment of the present invention.

FIG. 4 illustrates a cross-sectional view of the rechargeable battery of FIG. 3, taken along the line IV-IV.

FIG. 5 illustrates a perspective view of a fuse member of a battery module, according to an exemplary embodiment of the present invention.

FIG. 6 and FIG. 7 schematically illustrate top views for description of operation of a fuse member included in a rechargeable battery module according to an exemplary embodiment of the present invention.

FIG. 8 schematically illustrates a top view of a battery module according to another exemplary embodiment of the present invention.

FIG. 9 schematically illustrates a top view for description of operation of a fuse member in the battery module of FIG. 8.

Description of Reference Numerals Indicating
Some Elements in the Drawings

| | |
|---|---|
| 10: electrode assembly | 11: first electrode |
| 11a, 12a: uncoated portion | 12: second electrode |
| 13: separator | 21: first terminal |
| 22: second terminal | 25: connection terminal |
| 26: case | 30: cap assembly |
| 31: cap plate | 32: injection opening |
| 34: vent hole | 37: short-circuit hole |
| 38: sealing stopper | 39: vent plate |
| 39a: notch | 41: first current collecting member |
| 42: second current collecting member | 43: lower insulation member |
| 54: upper insulation member | 56: short-circuit member |
| 56a: opening | 58: cap connection member |
| 59: sealing gasket | 72: first draw-out tab |
| 73: second draw-out tab | 77: protrusion |
| 100: battery module | 101, 101a, 101b, 101c: |
| | rechargeable battery |
| 125: connection member | 200: fuse member |
| 202: connection plate | 204: fuse |

### DETAILED DESCRIPTION

Aspects and features of some exemplary embodiments of the present invention are described more fully herein with reference to the accompanying drawings, in which some exemplary embodiments of the present invention are shown. The present invention may, however, be embodied In different forms and should not be construed as limited to the embodiments set forth herein. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

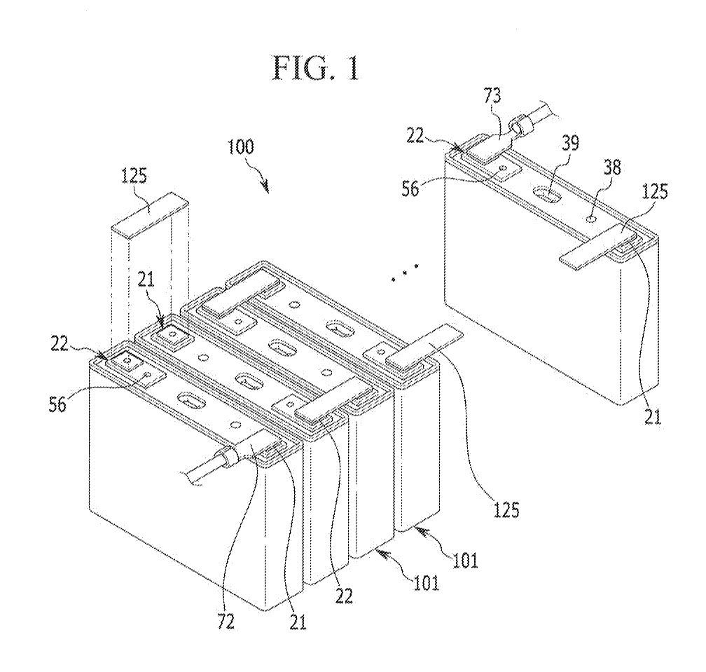

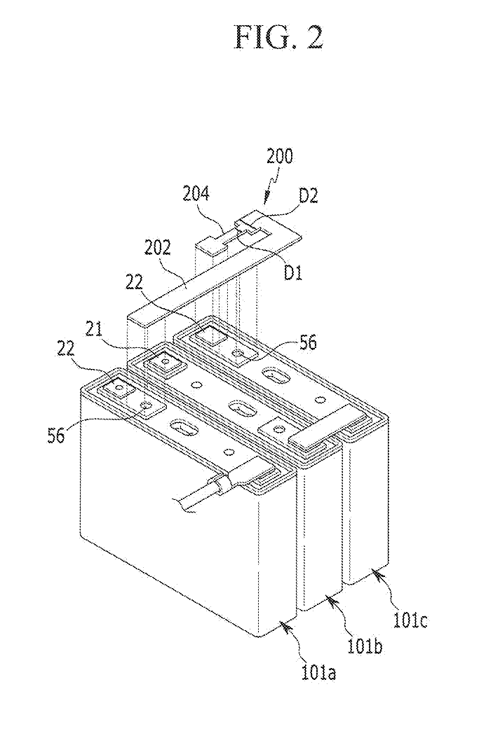

FIG. 1 illustrates a perspective view of a battery module according to art exemplary embodiment of the present invention; and FIG. 2 illustrates a perspective view of a fuse member provided in a battery module, according to an exemplary embodiment of the present invention.

Referring to FIG. 1, a battery module 100 according to an exemplary embodiment of the present invention includes a plurality of rechargeable batteries 101 that are continuously arranged.

The plurality of rechargeable batteries 101 are electrically connected in series with each other. A first draw-out tab 72 is provided for drawing out a current in a first terminal 21 of a rechargeable battery 101 disposed at one end of the serially connected rechargeable batteries 101, and a second draw-out tab 73 is provided for drawing out a current in a second terminal 22 of a rechargeable battery 101 disposed at the other end of the serially connected rechargeable batteries 101. The first draw-out tab 72 and the second draw-out tab 73 may be connected with a module terminal to transfer a current to a device where the battery module 100 is installed.

For convenience of description, a rechargeable battery connected with the first draw-out tab 72 will be called a first rechargeable battery, and rechargeable batteries will be sequentially called a second rechargeable battery to an n-th rechargeable battery toward the second draw-out tab 73.

The rechargeable batteries 101, in one embodiment, are electrically serially connected with each other by a connection member 125. The connection member 125 may be a long plate-shaped conductor, and electrically connects first terminals 21 and second terminals 22 between neighboring rechargeable batteries 101. In this case, the first terminal 21 and the second terminal 22 may have different polarities. For example, if the first terminal 21 is a positive terminal, the second terminal 22 may be a negative terminal.

In the battery module 100 according to one or more embodiments of the present Invention, a fuse member 200 is provided to prevent or substantially prevent explosion due to an abnormal reaction in the rechargeable battery 101.

Referring to FIG. 2, the fuse member 200 according to an exemplary embodiment of the present invention includes a connection plate 202 for connecting a plurality of second terminals 22 and a fuse 204 connected with one end of the connection plate 202.

The connection plate 202 may overlap the plurality of rechargeable batteries 101 included in the battery module 100, and may be formed in the shape of a long plate that horizontally crosses the battery module 100. In this case, the connection plate 202 may he disposed to be overlapped with short-circuit members 58 of the rechargeable batteries 101 included in the battery module 100 and, in an exemplary embodiment, overlaps short-circuit members 58 of alternately arranged, i.e. odd-numbered, rechargeable batteries 101 from an end of the plurality of rechargeable batteries 101.

The fuse 204 has a first width D1 that is narrower than other portions of the fuse member 200, and is formed narrower than a second width D2 of a portion connected with the connection plate 202. As described, when the first width. D1 is formed to be narrower than other portions, a cross-section of the fuse 204 is reduced so that the fuse 204 can be easily cut by being melted when an over-current flows.

In FIG. 2, the connection plate 202 of the fuse member 200 is disposed to correspond to three consecutive rechargeable batteries 101a, 101b, and 101c and thus overlaps two short-circuit members 56, but embodiments the present invention are not limited thereto. That is, in other embodiments, the connection plate 202 of the fuse member 200 can be variously connected in a unit group including odd-numbered rechargeable batteries.

The rechargeable battery 101 according to an exemplary embodiment of the present invention will be described below in further detail with reference to the accompanying drawings.

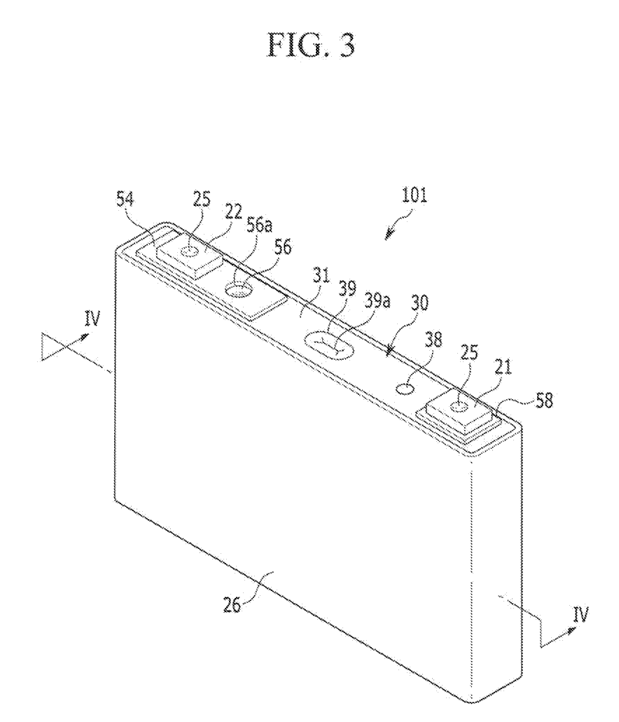

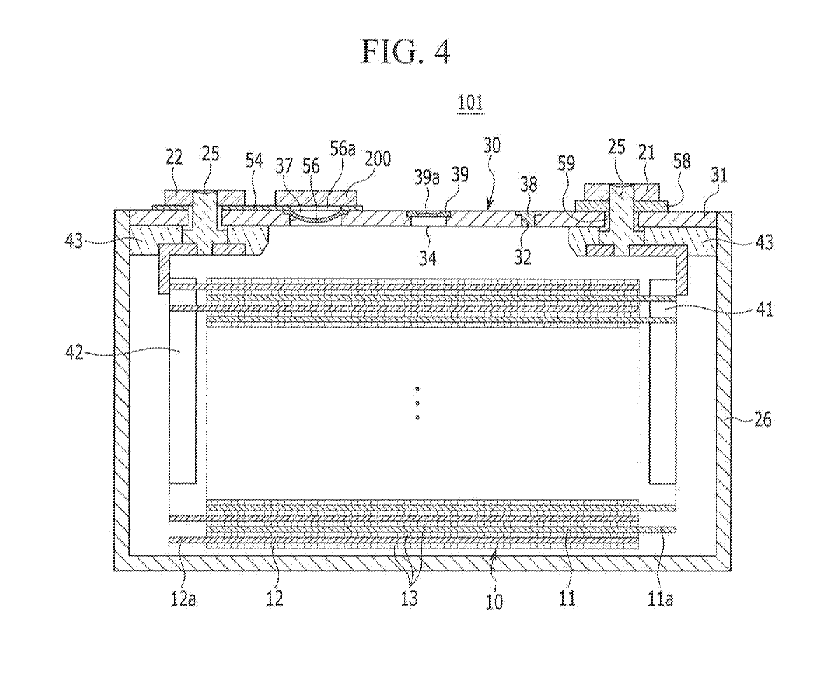

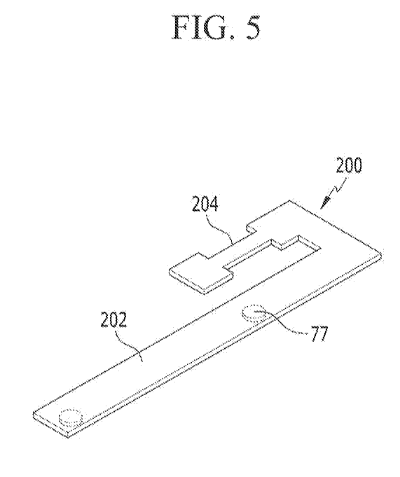

FIG. 3 illustrates a perspective view of the rechargeable battery 101 according to an exemplary embodiment of the present invention; FIG. 4 illustrates a cross-sectional view of the rechargeable battery 101, taken along the line IV-IV of FIG. 3; and FIG. 5 illustrates a perspective view of a fuse member of a battery module, according to an exemplary embodiment of the present invention.

Referring to FIG. 3 and FIG. 4, the rechargeable battery 101 according to an exemplary embodiment of the present invention includes an electrode assembly 10 formed by spirally winding, for example, a first electrode (e.g., a positive electrode) 11 and a second electrode (e.g., a negative electrode) 12 while interposing a separator 13 therebetween, a case 26 in which the electrode assembly 10 is installed, and a cap assembly 30 combined to an opening of the case 26.

The rechargeable battery 101 according to an exemplary embodiment of the present invention will be exemplarily described as a prism-shaped lithium ion secondary battery. However, the present invention is not limited thereto, and the present invention may be applied to various types of batteries such as a lithium polymer battery or a cylindrical battery.

The first electrode 11 and the second electrode 12, according to an exemplary embodiment, include coated: portions where an active material is coated to a current collector that is formed of a thin plate metal foil, and uncoated portions 11a and 12a where the active material is not coated. A first electrode uncoated portion 11a is formed at one end of the first electrode 11 along a length direction of the first electrode 11, and a second uncoated portion 12a is formed at the other end of the second electrode 12 along a length direction of the second electrode 12. The first electrode 11 and the second electrode 12, in one embodiment, are spirally wound, while interposing the separator 13, which is an insulator, therebetween.

However, the present invention is not limited thereto, and, in other embodiments, the electrode assembly 10 may have a structure in which a positive electrode and a negative electrode formed of a plurality of sheets are layered, interposing a separator therebetween.

The case 26, in one embodiment, is substantially formed in the shape of a cuboid and has an opening formed in one side thereof. The case 26 may he made of a metal, such as aluminum, stainless steel, and the like.

The cap assembly 30 includes a cap plate 31 covering the opening of the case 26, the first terminal 21 protruded to the outside of the cap plate 31 and electrically connected with the first electrode 11, and the second terminal 22 protruded to the outside of the cap plate 31 and electrically connected with the second electrode 12.

The cap plate 31, in one embodiment/is formed in the shape of a plate extended in a direction, and is combined to the opening of the case 26. In one embodiment, a sealing stopper 38 is formed in an electrolyte injection opening 32 formed in the cap plate 31, and a vent plate 39 is provided in a vent hole 34 and has a notch 39a formed therein so as to be opened at a certain pressure (e.g., a predetermined pressure). The first terminal 21 and the second terminal 22 protrude upward from the cap plate 31.

In one; embodiment, the first terminal 21 is electrically connected with the first electrode 11 through a first current collecting member 41, and the second terminal 22 is electrically connected with the second electrode 12 through a second current collecting member 42. However, the present Invention is not limited thereto, and, in another embodiment, the first terminal 21 may be electrically connected to the second electrode (e.g., the negative electrode) 12 and the second terminal 22 may be electrically connected to the first electrode (e.g., the positive electrode) 11.

The first terminal 21, in one embodiment, is formed in the shape of a quadrangular plate and is electrically connected with the first electrode 11 through a connection terminal 25 bonded to the first current collecting member 41. In one embodiment, the connection terminal 25 combined to the first terminal 21 and a connection terminal 25 combined to the second terminal 22 have a same or similar structure.

In one embodiment, a sealing gasket 59 is inserted for sealing between the first terminal 21 and the cap plate 31 in a hole through which the connection terminal 25 is penetrated, and a lower insulation member 43 that supports the first current collecting member 41 is provided below the cap plate 31.

In one embodiment, a cap connection member 53 that electrically connects the first terminal 21 and the cap plate 31 is provided below the first terminal 21, such that the cap plate 31 and the case 26 have a same polarity as the first terminal 21 (e.g., positively charged).

The second terminal 22, in one embodiment, is formed in the shape of a quadrangular plate and is electrically connected with the second electrode 12 through the connection terminal 25 bonded to the second current collecting member 42. In one embodiment, the connection terminal 25 penetrates through the cap plate 31 and the second terminal 22, and an upper end of the connection terminal 25 is fixed to the second terminal 22.

In one embodiment, a sealing gasket 59 is inserted for sealing between the second terminal 22 and the cap plate 31 in a hole through which the connection terminal 25 is penetrated, and a lower insulation member 43 that insulates the second terminal 22 and the second current collecting member 42 from the cap plate 31 is provided below the cap plate 31. An upper insulation member 54 is provided for insulation between the second terminal 22 and the cap plate 31. The upper insulation member 54 is extended to a short-circuit hole 37, and an opening 56a provided above the short-circuit hole 37 and connected with the short-circuit hole 37 is formed in the upper insulation member 54.

The cap assembly 30 includes a short-circuit member 56 for short circuiting the first electrode 11 and the second electrode 12, and thus, in one embodiment, the short-circuit member 56 is electrically connected with the cap plate 31 and is deformed when an internal pressure of the rechargeable battery 101 is increased, thereby causing a short circuit.

The short-circuit hole 37 is provided in the cap plate 31, and the short-circuit member 56 is provided between the upper insulation member 54 and the cap plate 31 in the short-circuit hole 37. The short-circuit member 56, in one embodiment, includes an arc-shaped bent portion bent convexly downward during normal operation and an edge portion formed at an outer side of the bent portion and fixed to the cap plate 31. The short-circuit member 56 is provided below the opening 55a during normal operation.

The short-circuit member 58. In one embodiment, is provided between the second terminal 22 and the vent hole 34, and is disposed adjacent to the second terminal 22.

The connection plate 202 of the fuse member 200 is disposed above the upper insulation member 54 that overlaps the short-circuit member 58. The connection plate 202 may be disposed to be overlapped with the short-circuit members 56 of a plurality of the rechargeable batteries as shown in FIG. 2. The fuse member 200 is provided to be insulated from the cap plate 31 while overlapping the upper insulation member 54.

As shown in FIG. 5, protrusions 77 may be formed on one side of the connection plate 202. The protrusions 77 may protrude toward the inside of the short-circuit hole 37 and, in an exemplary embodiment, are smaller than a diameter of the short-circuit hole 37 as so as be inserted into the short-circuit hole 37. In this case, a planar shape of the protrusions 77 may be a circle or a polygon, and may have a same planar shape as the short-circuit hole 37.

When the protrusions 77 are formed, the short-circuit member 56 and the protrusions 77 contact each other when the short-circuit member 56 is reversely deformed, and the short-circuit member 56 and the protrusions 77 contact each other such that a contact area can be increased compared to a contact area between the short-circuit member 58 and the connection plate 202.

As described, in the exemplary embodiments of the present invention, explosion of the rechargeable battery due to overcharging can be easily prevented or substantially prevented by overlapping the fuse member 200 and the short-circuit member 56.

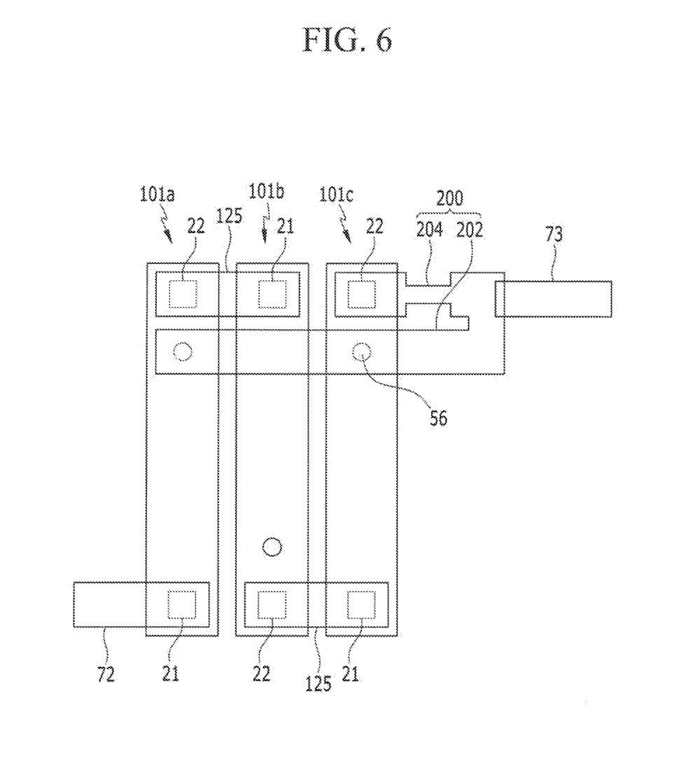

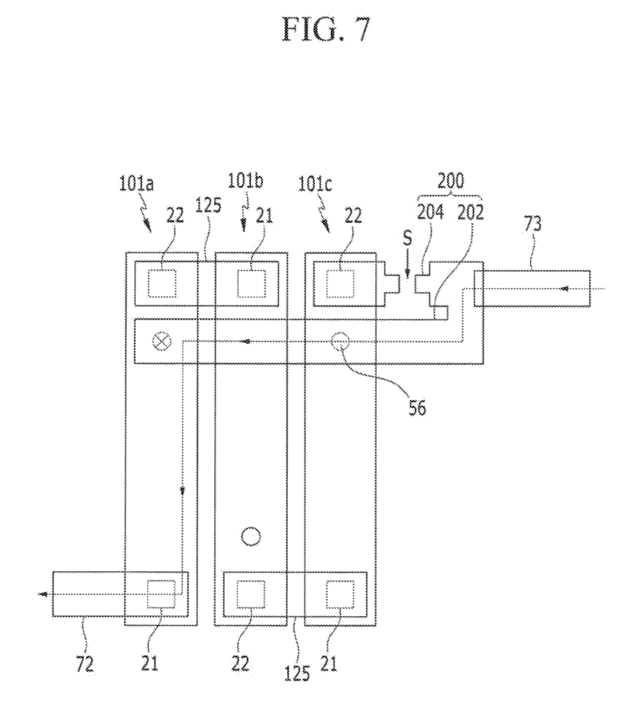

This will be described in further detail with reference to FIG. 6 and FIG. 7.

FIG. 6 and FIG. 7 schematically illustrate top views for description of operation of a fuse member included, in a rechargeable battery module according to an exemplary embodiment of the present invention.

The rechargeable battery module of FIG. 6 and FIG. 7 may include odd-numbered rechargeable batteries, and three rechargeable batteries connected in series will be exemplarily described. In this case, FIG. 6 illustrates a top View of a rechargeable battery module before occurrence of overcharge, and FIG. 7 illustrates a top view of the rechargeable battery after occurrence of overcharge.

First, as shown in FIG. 6, first terminals 21 and second terminals 22 of three rechargeable batteries 101a, 101b, and 101c are serially connected with each other by connection members 125. Thus, in order to continuously connect the first terminals 21 and the second terminals 22 with the connection members 125, the first terminals and the second terminals may be alternately arranged in the rechargeable batteries 101a, 101b, and 101c.

Thus, the connection plate 202 of the fuse member 200 is disposed to be overlapped with the short-circuit members 58 of a first rechargeable battery 101a and a third rechargeable battery 101c.

The first terminal 21 of the first rechargeable battery 101a is connected with the first draw-out tab 72, and the second terminal 22 of the third rechargeable battery 101c is connected with the second draw-out tab 73.

An abnormal reaction may occur in a rechargeable battery due to various internal or external reasons of the rechargeable battery module shown in FIG. 6.

When the abnormal reaction occurs in the rechargeable battery, gas is generated and an internal pressure of the rechargeable battery is increased. When the Internal pressure of the rechargeable battery becomes higher than a certain pressure (e.g., a predetermined pressure), the bent portion of the short-circuit member 58 become convex toward the opposite direction and thus contacts the bottom surface of the connection plate 202 of the fuse member 200, thereby causing a short circuit.

As shown in FIG. 7, when an abnormal reaction occurs in the first rechargeable battery 101a, the short-circuit member 58 of the first rechargeable battery 101a is reversely deformed and thus contacts the bottom surface of the connection plate 202 of the fuse member 200, and accordingly the fuse 204 is cut and thus a disconnected portion S is formed.

In one embodiment, the short-circuit member 58 fixed to a side wall of the short-circuit hole 37 formed in the case 26 is electrically connected with the first terminal 21, which is a positive electrode, by the case 28 that is electrically connected to the first terminal 21 through the cap connection member 58, and the fuse member 200 is electrically connected by contacting with the second terminal 22, which is a negative, electrode.

Thus, when the short-circuit member 38 is reversely deformed and thus contacts the fuse member 200 thereabove, the short-circuit member 58, which is a positive electrode, and the fuse member 200, which is a negative electrode contact each other, thereby causing a short circuit. Accordingly, a short-circuit current that is dozens of times greater than a rated current flows, and the short-circuit current is transferred to the fuse 204 through the connection plate 202 of the fuse member 200. The fuse 204 is a portion having a relatively narrow width, and thus is cut by being melted by a rapidly increased short-circuit current. In one embodiment, a melting temperature of the fuse 204 is set to be lower than a melting temperature of the short-circuit member 56 for melting of the fuse 204.

As described, when the fuse member 200 is provided as in the exemplary embodiment of the present invention, the fuse 204 is cut when the short-circuit current is generated and thus the disconnected portion S is formed, and accordingly the flow of the short-circuit current car be bypassed.

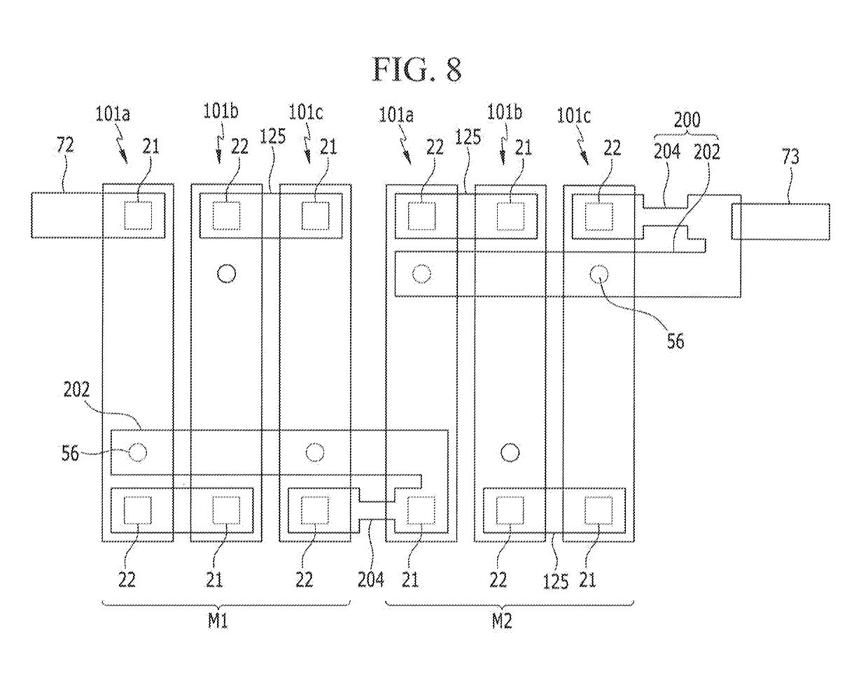

FIG. 8 schematically illustrates a top view of a battery module according to another exemplary embodiment of the present invention.

The battery module of FIG. 8 is similar to the battery module of FIG. 1 to FIG. 4, and therefore only a different portion will be described.

The battery module of FIG. 8 includes a plurality of unit groups M1 and M2 that are electrically connected in series. Here, the battery module of FIG. 2 is shown as the unit group for purposes of illustration. In an exemplary embodiment, each of the unit groups M1 and M2 Includes an odd number of rechargeable batteries, and the rechargeable batteries included In each module are connected in series. A fuse member 200 may he provided in each of the unit groups M1 and M2.

As shown in FIG. 8, the unit groups M1 and M2 including an odd number of rechargeable batteries may be connected to even-numbered unit groups such that a battery module including an even number of rechargeable batteries can be provided.

As shown in FIG. 8, when rechargeable batteries are connected as a plurality of unit groups and overcharge occurs in one rechargeable battery, electric power can be generated using unit groups other than a unit group including the rechargeable battery where the overcharge occurred.

This is described further below with reference to FIG; 9.

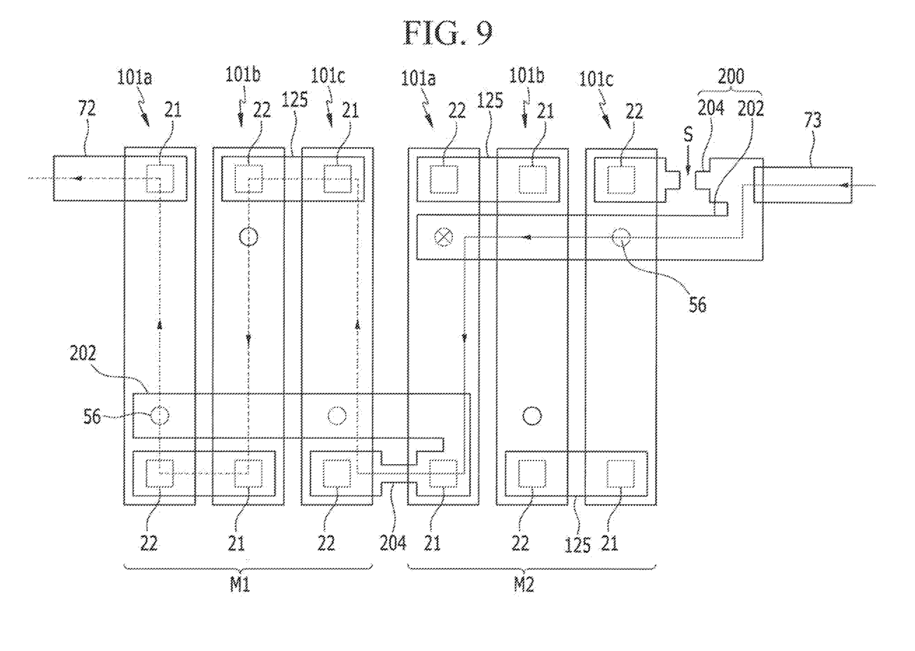

FIG. 9 schematically illustrates a top view for description of operation of the fuse member in the battery module of FIG. 8.

In the battery module of FIGS. 8 and 9, the first unit group M1 and the second unit group M2 are electrically connected with each other in series, and a short circuit is illustrated to occur in a rechargeable battery In the second unit group M2.

As shown in FIG. 9, when an abnormal reaction occurs in a first rechargeable battery 101a of the second unit group M2, the short-circuit member 56 of the first rechargeable battery 101a contacts the fuse member 200 included in the second unit group M2 and is thus short-circuited.

In this case, a short-circuit current generated from the short circuit is transferred to the fuse 204 through the connection plate 202 of the fuse member 200 and thus the fuse 204 is melted, thereby forming a disconnected portion S.

As described, when a fuse of the second unit group M2 is out due to an abnormal operation of the second unit group M2, rechargeable batteries included in the second unit group M2 are no longer operated.

Thus, a current generated from the first unit group M1 is bypassed by the second draw-out tab 73 connected with the second unit group M2 and the connection plate 202 of the second unit group M2 such that the current is directly transferred to the fuse member 200 of the first unit group M1.

In the above-described exemplary embodiment, two unit groups are connected, but, in other embodiments of the present invention, more than two unit groups can be serially connected.

For example, in another embodiment, a short circuit may occur in a second unit group in a battery module in which a first unit group, the second unit group, and a third unit group are sequentially connected, and a fuse of a fuse member disposed in the second unit group is cut and thus the fuse is disconnected. Accordingly, no more current is generated from rechargeable batteries of the second unit group, and currents generated from the first and third unit groups bypass the second unit group by a connection plate of the second unit group.

As shown in FIG. 9, when rechargeable batteries are connected using unit groups, each having a fuse member, a current is bypassed by a connection plate 202 of a fuse member 200 in a unit group where an abnormal reaction has occurred so that only rechargeable batteries of unit groups where no abnormal reaction has occurred can be used.

While this invention has been described in connection with what is presently considered to be some exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. A battery module comprising:
a plurality of rechargeable batteries electrically connected in series with each other, each comprising a short-circuit member that is deformable according to an increase of an internal pressure; and
a fuse member including a connection plate overlapping the short-circuit member and a fuse including a first end connected with the connection plate and a second end connected with a first electrode or a second electrode of one of a first rechargeable battery and a second rechargeable battery located at an end along the plurality of rechargeable batteries.

2. The battery module of claim 1, wherein the fuse member is connected with the second electrode of the second rechargeable battery.

3. The battery module of claim 1, wherein the fuse is narrower than a width of a portion of the fuse member connected with the connection plate.

4. The battery module of claim 1, further comprising:
a first draw-out tab connected with the first electrode of the first rechargeable battery; and
a second draw-out tab connected with the fuse member.

5. The battery module of claim 1, wherein the battery module comprises at least one unit group, each including an odd number of rechargeable batteries of the plurality of rechargeable batteries.

6. The battery module of-claim 5; wherein the fuse member includes one or more fuse members overlapping a short-circuit member of a rechargeable battery included in each unit group.

7. The battery module of claim 8, wherein the connection plate of each of the one or more fuse members overlaps the short-circuit member of a second rechargeable battery located at an end of the rechargeable batteries included in each of the unit groups.

8. The battery module of claim 1,
wherein the rechargeable battery comprises an electrode assembly including a positive electrode and a negative electrode and configured to perform charging and discharging, a case in which the electrode assembly is installed, and a cap plate combined to the case, and
wherein the cap plate and the first electrode are electrically connected with the positive electrode, and the second electrode is electrically connected with the negative electrode.

9. The battery module of claim 8, wherein the cap plate has a shape of a plate having a length direction and a width direction, and the short-circuit member is arranged closer to a center of the length direction of the cap plate than the second electrode.

10. The battery module of claim 8, wherein the cap plate comprises a short-circuit hole penetrating the cap plate, and the short-circuit member comprises an edge portion fixed to the cap plate in the short-circuit hole.

11. The battery module of claim 10, wherein the connection plate comprises protrusions protruded toward the short-circuit hole.
